(19) United States
(12) Patent Application Publication
(10) Pub. No.: US 2026/0024355 A1
(43) Pub. Date: Jan. 22, 2026

(54) ROAD MANAGEMENT SYSTEM, ROAD MANAGEMENT METHOD, AND NON-TRANSITORY COMPUTER READABLE MEDIUM

(71) Applicant: NEC Corporation, Minato-ku, Tokyo (JP)

(72) Inventors: Shintaro CHIKU, Tokyo (JP); Naoko FUKUSHI, Tokyo (JP); Masanori KUKI, Tokyo (JP); Shuei YAMADA, Tokyo (JP); Shuhei MIZUGUCHI, Tokyo (JP); Kosei KOBAYASHI, Tokyo (JP)

(73) Assignee: NEC Corporation, Minato-ku, Tokyo (JP)

(21) Appl. No.: 18/994,670

(22) PCT Filed: Aug. 1, 2022
(86) PCT No.: PCT/JP2022/029491

§ 371 Date: Jan. 15, 2025

(51) Int. Cl. G06V 20/56; G06V 10/60; G06V 20/58; G08G 1/005

(52) U.S. Cl. CPC G06V 20/588; G06V 10/60; G06V 20/58; G08G 1/005

(57) ABSTRACT

A road management system (10) includes: space detection means (11) for detecting a space on an auxiliary road where a mobile body other than a vehicle moves based on sensing information obtained by sensing the auxiliary road, the auxiliary road being provided on a side of a roadway where the vehicle travels; interrupted section specification means (12) for specifying a section of the auxiliary road in which a whole or part of the auxiliary road is interrupted based on the space on the auxiliary road detected by the space detection means (11); and reflection means (13) for reflecting the section of the auxiliary road in which a whole or part of the auxiliary road is interrupted specified by the interrupted section specification means (12) in a database.

### TECHNICAL FIELD

The present disclosure relates to a road management system, a road management method, and a non-transitory computer readable medium.

### BACKGROUND ART

In recent years, a driver assistance technology for grasping a road environment has been developed in order to achieve a safe and smooth driving.

Patent Literature 1 discloses a driver assistance apparatus that notifies a driver of avoidance instruction information for bypassing an obstacle in a roadway during traveling. The driver assistance apparatus detects an obstacle on a roadway during driving by a sensor mounted on a vehicle, and determines whether or not there is a space for bypassing the detected obstacle by a sensor installed in an infrastructure. The driver assistance apparatus notifies a driver of a result of the determination as to whether or not there is such a space.

### CITATION LIST

### Patent Literature

Patent Literature 1: Japanese Unexamined Patent Application Publication No. 2020-201544

### SUMMARY OF INVENTION

### Technical Problem

The above-described driver assistance apparatus disclosed in Patent Literature 1 senses a space for bypassing an obstacle in a roadway by a sensor installed in an infrastructure. However, the above-described sensing apparatus may not be able to sense, for example, a sidewalk where the visual field of the driver is obstructed by street trees or external walls, and thus safety cannot be sufficiently ensured.

In view of the problem described above, an object of the present disclosure is to provide a road management system, a road management method, and a non-transitory computer readable medium by which it is possible to ensure a higher level of safety during driving.

### Solution to Problem

A road management system according to one example aspect of the present disclosure includes:
space detection means for detecting a space on an auxiliary road where a mobile body other than a vehicle moves based on sensing information obtained by sensing the auxiliary road, the auxiliary road being provided on a side of a roadway where the vehicle travels;
interrupted section specification means for specifying a section of the auxiliary road in which a whole or part of the auxiliary road is interrupted based on the space on the auxiliary road detected by the space detection means; and
reflection means for reflecting the section of the auxiliary road in which a whole or part of the auxiliary road is interrupted specified by the interrupted section specification means in a database.

A road management method according to one example aspect of the present disclosure includes:
detecting a space on an auxiliary road where a mobile body other than a vehicle moves based on sensing information obtained by sensing the auxiliary road, the auxiliary road being provided on a side of a roadway where the vehicle travels;
specifying a section of the auxiliary road in which a whole or part of the auxiliary road is interrupted based on the detected space on the auxiliary road; and
reflecting the specified section of the auxiliary road in which a whole or part of the auxiliary road is interrupted in a database.

A non-transitory computer readable medium according to one example aspect of the present disclosure stores a program for causing a computer to:
detect a space on an auxiliary road where a mobile body other than a vehicle moves based on sensing information obtained by sensing the auxiliary road, the auxiliary road being provided on a side of a roadway where the vehicle travels;
specify a section of the auxiliary road in which a whole or part of the auxiliary road is interrupted based on the detected space on the auxiliary road; and
reflect the specified section of the auxiliary road in which a whole or part of the auxiliary road is interrupted in a database.

### Advantageous Effects of Invention

According to the present disclosure, it is possible to provide a road management system, a road management method, and a non-transitory computer readable medium that can ensure the safety of a mobile body.

### BRIEF DESCRIPTION OF DRAWINGS

FIG. 1 is a block diagram showing a configuration of a road management system according to a first example embodiment;

FIG. 2 is a diagram showing an example of a road management system according to a second example embodiment;

FIG. 3 is a block diagram showing a configuration of the road management system according to the second example embodiment;

FIG. 4 is a schematic diagram showing an example of a section of an auxiliary road in which a part of the auxiliary road is interrupted according to the second example embodiment;

FIG. 5 is a flowchart showing a road management method according to the second example embodiment;

FIG. 6 is a block diagram showing a configuration of a road management system according to a third example embodiment;

FIG. 7 is a schematic diagram showing a section of the auxiliary road in which brightness of the auxiliary road is less than or equal to a predetermined value according to the third example embodiment;

FIG. 8 is a flowchart showing a road management method according to the third example embodiment;

FIG. 9 is a block diagram showing a configuration of a road management system according to a fourth example embodiment; and

FIG. 10 is a schematic diagram showing a usage example of a road management method according to the fourth example embodiment.

### EXAMPLE EMBODIMENT

The present disclosure will be described hereinafter through example embodiments. However, the disclosure according to the claims is not limited to the following example embodiments. Further, all the components described in the example embodiments are not necessarily essential as means for solving the problem. The same elements are denoted by the same reference symbols throughout the drawings, and redundant descriptions are omitted as necessary.

### First Example Embodiment

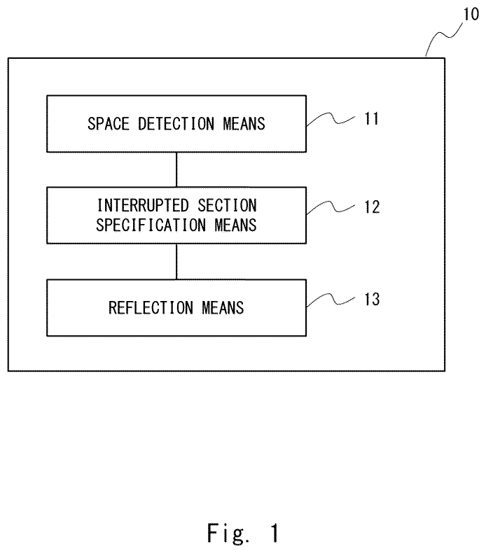

FIG. 1 is a block diagram showing a configuration of a road management system according to a first example embodiment. A sensing apparatus 10 according to the first example embodiment includes space detection means 11, interrupted section specification means 12, and reflection means 13.

The space detection means 11 detects a space on an auxiliary road where a mobile body other than a vehicle moves provided on a side of a roadway where a vehicle travels based on sensing information obtained by sensing the auxiliary road. In this example, the roadway refers to a part of a road where a vehicle travels. Meanwhile, the auxiliary road is a way where a mobile body other than a vehicle, such as a pedestrian, a bicycle, and a robot, moves, and is provided on the side of the roadway. A typical example of an auxiliary road is a sidewalk.

The interrupted section specification means 12 specifies a section of the auxiliary road in which a whole or part of the auxiliary road is interrupted based on the space on the auxiliary road detected by the space detection means 11.

The section of the auxiliary road in which the auxiliary road is interrupted refers to a section of the auxiliary road including a space which cannot be detected by a vehicle traveling on the roadway in a whole or part of the auxiliary road in the width direction. In other words, the section of the auxiliary road in which the auxiliary road is interrupted refers to a section of the auxiliary road including a space which cannot be seen or is difficult to be seen from a vehicle, that is, a space in a blind spot on the auxiliary road.

The reflection means 13 reflects a section of the auxiliary road in which a space other than the roadway is interrupted in a database. The database is, for example, an online map or a search engine. The database is not necessarily provided inside the sensing apparatus, and may be connected to the sensing apparatus through a communication network.

As described above, the road management system according to the first example embodiment specifies an interrupted section of the auxiliary road and reflects it in a database. Thus, the safety can be ensured. For example, the safety of a vehicle traveling on a roadway or a mobile body traveling on an auxiliary road can be ensured. Further, information useful for road maintenance and management can be provided to a user such as a road administrator. Thus, a user such as a road administrator can easily make a plan for cutting trees and removing external walls.

### Second Example Embodiment

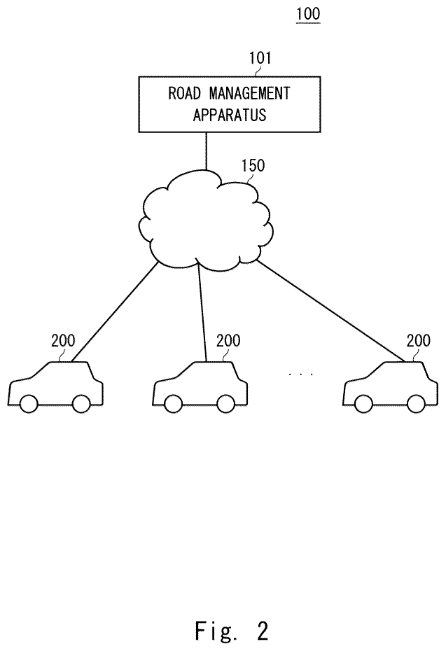

A second example embodiment of the present disclosure will be described below with reference to the drawings. FIG. 2 shows a road management system including a road management apparatus according to an example embodiment of the present disclosure. A road management system 100 includes a road management apparatus 101 and one or more vehicles 200. The road management apparatus 101 is connected to one or more of the vehicles 200 through a network 150. The network 150 includes, for example, a wireless communication network using a communication line standard such as Long Term Evolution (LTE). The network 150 may include a wireless communication network such as WiFi (registered trademark) or a fifth generation mobile communication system.

The vehicle 200 may be configured, for example, as a land vehicle such as an automobile, a bus, a taxi, or a truck. The vehicle 200 may be a vehicle such as an official vehicle, a garbage collecting vehicle, or a police vehicle. The vehicle 200 includes a peripheral monitoring sensor for monitoring the surroundings of a mobile body. The peripheral monitoring sensor includes, for example, a camera and a sensor such as Light Detection and Ranging (LiDAR). The vehicle 200 may be configured so as to be able to perform automated driving (autonomous driving) based on information from a sensor mounted on a mobile body.

A communication apparatus is mounted on the vehicle 200, and the communication apparatus transmits sensor data (sensing information) of the peripheral monitoring sensor to a road management system 110. For example, the vehicle 200 transmits a camera image captured by a camera, three-dimensional point cloud data acquired by the LiDAR, or both of them as sensor data to the road management system 110. An example of a case in which the vehicle 200 includes a camera and transmits a camera image to the road management system 110 will be described below. The vehicle 200 may include a plurality of cameras that capture images of the front, rear, right, and left sides of the vehicle.

The road management system 110 detects a space on the auxiliary road using sensor data transmitted from the vehicle 200, specifies a section of the auxiliary road in which a whole or part of the auxiliary road is interrupted, and reflects it in a database.

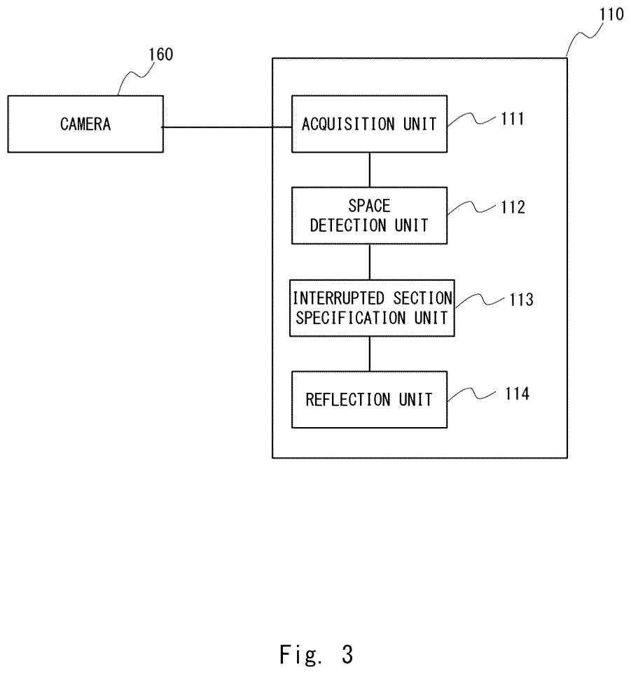

FIG. 3 shows an example of a configuration of the road management system 110. The road management system 110 includes an acquisition unit 111, a space detection unit 112, an interrupted section specification unit 113, and a reflection unit 114. The road management system 110 is configured as a computer apparatus including, for example, one or more memories and one or more processors. At least some of the functions of the respective units of the road management system 110 may be implemented by the processor operating in accordance with a program read from the memory.

The road management system 110 corresponds to a road management system 10 shown in FIG. 1.

The acquisition unit 111 acquires a camera image from a camera 160. The camera 160 is mounted on the vehicle 200 (see FIG. 2). In this example embodiment, the camera 160 may transmit a camera image obtained by capturing an image of a road to the road management system 110, and is not necessarily mounted on the vehicle 200. The camera 160 may be installed in a traffic signal or a roadside unit other than a vehicle. The acquisition unit 111 may acquire three-dimensional point cloud data (a LiDAR image) including data of a road area from a three-dimensional scanner such as LiDAR in place of or in addition to the camera image.

The space detection unit 112 detects a space on the auxiliary road from a camera image captured by the camera 160. For example, the space detection unit 112 detects a curb or a guardrail on the road, thereby detecting a space on the auxiliary road. The curb can be detected, for example, by searching for an area including a predetermined step in the camera image. The space detection unit 112 corresponds to the space detection means 11 shown in FIG. 1.

The interrupted section specification unit 113 specifies a section of the auxiliary road in which a whole or part of the auxiliary road is interrupted based on the space on the auxiliary road detected by the space detection unit 112 based on the camera image. In a case where a part of a section of the auxiliary road having a predetermined length cannot be detected even though a space on the auxiliary road has been detected before and behind it, the interrupted section specification unit 113 may specify the space as an interrupted section. At this time, in order to prevent a section of the auxiliary road in which a guardrail is installed from being recognized as an interrupted section, it is preferable to recognize only a space having a height greater than or equal to a predetermined height, and determine whether or not there is no obstacle and the space can be detected.

Further, in order to prevent a mobile body such as a pedestrian from being recognized as an obstacle, it may be determined whether or not the detected object is moving.

Furthermore, by measuring the same section of the auxiliary road a plurality of times, it may be determined whether or not the obtained results of the detection are identical.

In addition, the interrupted section specification unit 113 may specify an interrupted section of the auxiliary road by comparing an auxiliary road corresponding to the space on the auxiliary road detected by the space detection unit 112 with past data of the auxiliary road. The interrupted section specification unit 113 checks, for example, an auxiliary road corresponding to the space on the auxiliary road detected by the space detection unit 112 against a construction ledger (a construction record) of the auxiliary road or past inspection data, thereby specifying a section of the auxiliary road in which a dividing line is interrupted. The construction ledger and the past inspection data may be acquired, for example, from a database owned by a road administrator. The interrupted section specification unit 113 may check an auxiliary road corresponding to a result of the detection of the space on the auxiliary road by the space detection unit 112 against an auxiliary road corresponding to a result of the detection of the space on the auxiliary road by the space detection unit 112 in the past, thereby specifying an interrupted section of the auxiliary road.

The interrupted section specification unit 113 corresponds to the interrupted section specification means 12 shown in FIG. 1.

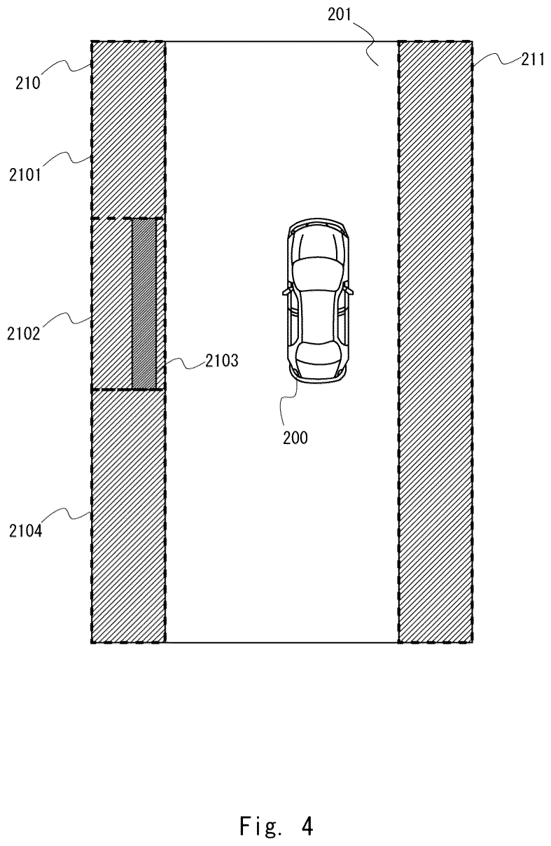

An example of an interrupted section of the auxiliary road specified by the interrupted section specification means 12 will be described below with reference to FIG. 4. FIG. 4 is a schematic diagram showing a section of the auxiliary road in which a part of the auxiliary road is interrupted. The road shown in FIG. 4 is formed of a roadway 201, a sidewalk 210, and a sidewalk 211. An obstacle 2103 obstructs the visual field of a driver so that the driver cannot see a part of the sidewalk 210 from the side of the roadway 201. The obstacle 2103 is, for example, a street tree, a plant, and an external wall. In a case where a driver of the vehicle 200 sees the sidewalk 210 from the side of the roadway 201, the visual field of the driver is obstructed by the obstacle 2103, and the driver cannot see a sidewalk 2102 behind the obstacle 2103. That is, in a case where a driver of the vehicle 200 sees the sidewalk 210 from the side of the roadway 201, the driver can see a sidewalk 2101 and a sidewalk 2104 of the sidewalk 210, but cannot see the sidewalk 2102 since the sidewalk 2102 appears to be interrupted to the driver. The sidewalk 2102 is an interrupted section in the auxiliary road.

Note that, in FIG. 4, although the interrupted section specification means 12 specifies one interrupted section in the auxiliary road, it is also possible to specify a plurality of interrupted sections in the auxiliary road.

The reflection unit 114 reflects the interrupted section of the auxiliary road in which a whole or part of the auxiliary road is interrupted specified by the interrupted section specification unit 113 in a database.

The reflection unit 114 corresponds to the reflection means 13 shown in FIG. 1.

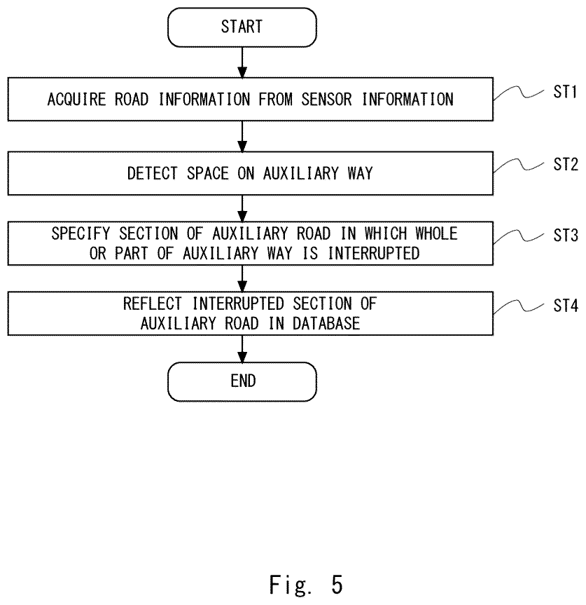

Next, a road management method according to a second example embodiment will be described. FIG. 5 shows a road management method according to an example embodiment of the present disclosure.

First, the acquisition unit 111 acquires road information from the camera 160 in the vehicle 200 (Step ST1). Next, the space detection unit 112 detects a space on an auxiliary road based on the road information acquired by the acquisition unit 111 (Step ST2). Next, the interrupted section specification unit 113 specifies a section of the auxiliary road in which a whole or part of the auxiliary road is interrupted based on the space on the auxiliary road detected by the space detection unit 112 (Step ST3). The reflection unit 114 reflects the interrupted section of the auxiliary road specified by the interrupted section specification unit 113 in a database (Step ST4).

An example of how to use database created by the reflection unit 114 will be described. The database created by the reflection unit 114 is distributed in advance to a terminal mounted on a vehicle (a vehicle-mounted terminal). The distribution method is, for example, a method for updating database of a vehicle-mounted terminal for each fixed period through a wireless network. Another example of the distribution method may be a method in which a vehicle-mounted terminal reads a memory in which the latest database is recorded, thereby updating the database. A driver of the vehicle can drive while paying attention to an interrupted section in the auxiliary road reflected in the database.

As described above, the road management system according to the second example embodiment specifies an interrupted section of the auxiliary road and reflects it in a database. Thus, the safety can be ensured. For example, the safety of a vehicle traveling on a roadway or a mobile body traveling on an auxiliary road can be ensured. Further, information useful for a road maintenance and management can be provided to a user such as a road administrator. Thus, a user such as a road administrator can easily make a plan for cutting trees and removing external walls.

### Third Example Embodiment

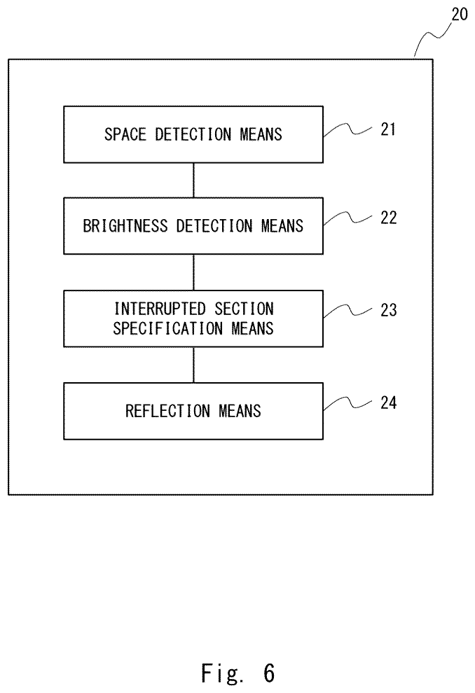

Next, a third example embodiment of the present disclosure will be described. FIG. 6 is a block diagram showing a configuration of a road management system according to the third example embodiment. A road management system 20 according to the third example embodiment includes space detection means 21, brightness detection means 22, interrupted section specification means 23, and reflection means 24. Since the space detection means 21 is similar to the space detection means 11 according to the first example embodiment, a description thereof will be omitted.

The brightness detection means 22 detects brightness of the space on the auxiliary road. Parameters that control the brightness are, for example, the season, the weather, the angle of the sun, and how close the trees are to being in full bloom.

The brightness detection means 22 can also detect the brightness by analyzing a brightness value of an image of the auxiliary road. Further, the brightness detection means 22 may detect the brightness of the auxiliary road based on information acquired from an illuminance sensor provided in the auxiliary road. For example, the illuminance sensor may be installed in a structure such as a traffic light, a street light, or a utility pole on or near the auxiliary road.

In addition to specifying a section of the auxiliary road in which a whole or part of the auxiliary road is interrupted, the interrupted section specification means 23 specifies a section of the auxiliary road in which brightness of a whole or part of the auxiliary road is less than or equal to a predetermined value.

In addition to the section of the auxiliary road in which a whole or part of the auxiliary road is interrupted, the reflection means 24 reflects a section of the auxiliary road in which the brightness of a whole or part of the auxiliary road is less than or equal to a predetermined value and the date and time in a database.

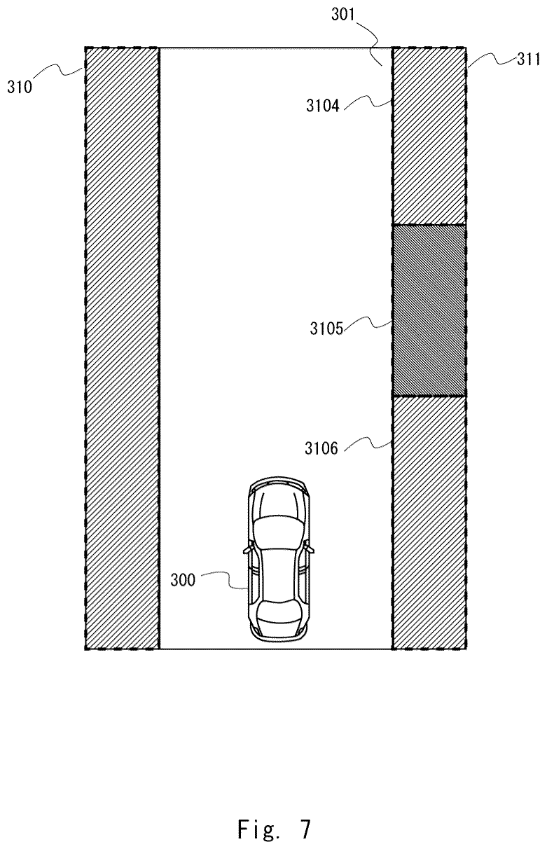

Since an interrupted section of the auxiliary road specified by the interrupted section specification means 23 corresponds to an interrupted section of the auxiliary road specified by the interrupted section specification means 12, a description thereof will be omitted. A section of the auxiliary road in which the brightness of the auxiliary road specified by the interrupted section specification means 23 is less than or equal to a predetermined value will be described below with reference to FIG. 7.

FIG. 7 is a schematic diagram showing the section of the auxiliary road in which the brightness of the auxiliary road is less than or equal to a predetermined value. The road shown in FIG. 7 is formed of a roadway 301, a sidewalk 310, and a sidewalk 311. It is assumed here that, as a result of analysis by the brightness detection means 22 based on sensor information obtained by sensing the road, the luminance values of the images of a sidewalk 3104 and a sidewalk 3106 are higher than a reference luminance value, and the luminance value of the image of a sidewalk 3105 is lower than a reference luminance value. In this case, the sidewalk 3104 and the sidewalk 3106 are bright sidewalks. On the other hand, the sidewalk 3105 is a dark sidewalk. That is, the sidewalk 3105 is a section of the auxiliary road in which the brightness thereof is less than or equal to a predetermined value.

Note that, in FIG. 7, although the interrupted section specification means 23 specifies one section of the auxiliary road in which the brightness of the auxiliary road is less than or equal to a predetermined value, it is also possible to specify a plurality of sections of the auxiliary road in which the brightness of the auxiliary road is less than or equal to a predetermined value.

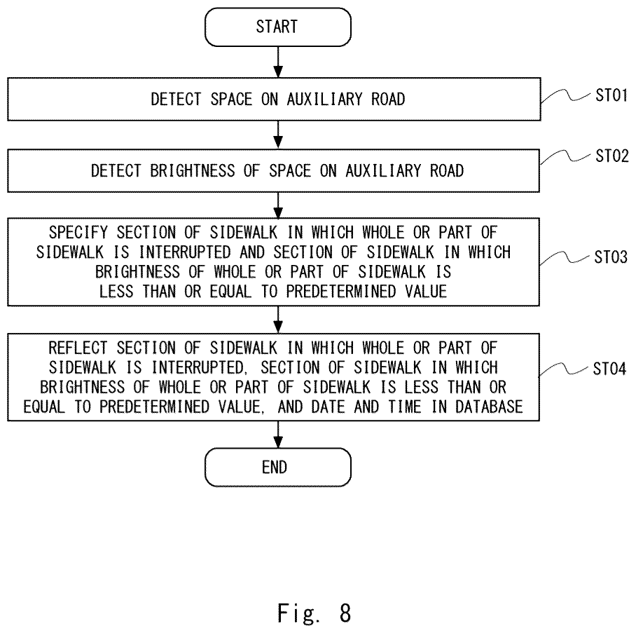

Next, a road management method according to the third example embodiment will be described. FIG. 8 is a road management method according to an example embodiment of the present disclosure. Note that FIG. 8 is a road management method performed after road information is acquired from sensor information.

The space detection means 21 detects a space on the auxiliary road based on the acquired road information (Step ST01). Next, the brightness detection means 22 detects brightness of the space on the auxiliary road detected by the space detection means 21 (Step ST02). Next, the interrupted section specification means 23 specifies a section of the auxiliary road in which a whole or part of the auxiliary road is interrupted and a section of the auxiliary road in which the brightness of a whole or part of the auxiliary road is less than or equal to a predetermined value (Step ST03). The reflection means 24 reflects the section of the auxiliary road in which a whole or part of the auxiliary road is interrupted, the section of the auxiliary road in which the brightness of a whole or part of the auxiliary road is less than or equal to a predetermined value, and the date and time in a database (Step ST04).

As described above, the road management system according to the third example embodiment specifies a section of the auxiliary road in which a whole or part of the auxiliary road is interrupted, a section of the auxiliary road in which the brightness of a whole or part of the auxiliary road is less than or equal to a predetermined value, and the date and time, and reflects then in a database. Thus, the safety can be ensured. For example, the safety of a vehicle traveling on a roadway or a mobile body traveling on an auxiliary road can be ensured. Further, information useful for a road maintenance and management can be provided to a user such as a road administrator. Thus, for example, a user such as a road manager can easily make a plan for installing a street light in a place where the brightness is insufficient. Further, for example, a user such as a manager of a municipality can alert a passerby by notifying the passerby that there is a dark section where the brightness is insufficient.

### Fourth Example Embodiment

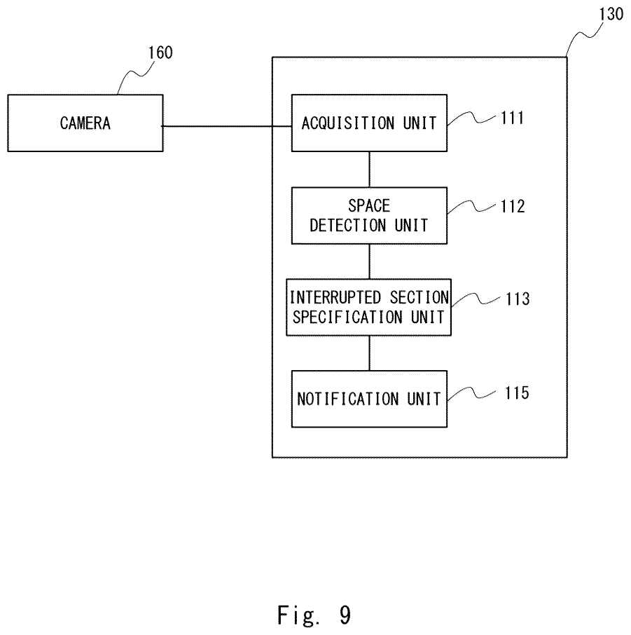

A road management system 130 according to a fourth example embodiment will be described. FIG. 9 shows an example of a configuration of the road management system 130. Since the acquisition unit 111, the space detection unit 112, and the interrupted section specification unit 113 of the road management system 130 according to the fourth example embodiment are similar to those of the road management system 110 according to the second example embodiment, the descriptions thereof will be omitted.

The notification unit 115 notifies a driver of the vehicle that there is a section of the auxiliary road in which a whole or part of the auxiliary road is interrupted specified by the interrupted section specification unit 113. The notification destination is typically a terminal installed in the vehicle 200. However, the notification destination may be a terminal other than that installed in the vehicle body, i.e., a terminal owned by a driver or a terminal owned by a pedestrian. Further, the notification method may be not only a method for sending a notification by sound, but also a method for sending a notification by combining sound and an image.

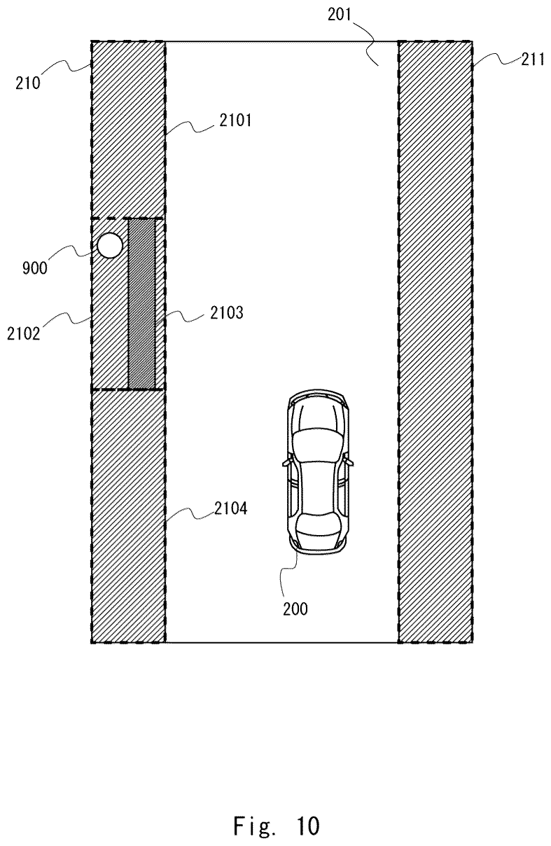

FIG. 10 is a schematic diagram showing a usage example of a road management method according to the fourth example embodiment. Since the roadway 201, the sidewalks 210, 211, 2101, 2102, and 2104, and the obstacle 2103 shown in FIG. 10 are similar to those shown in FIG. 2, the descriptions thereof will be omitted.

A description will be given of a case in which a mobile body 900 present on the sidewalk 2102 moves to the sidewalk 2101 or the sidewalk 2104 by bypassing the obstacle 2103 and thus may enter the roadway 201. It is difficult for a driver of the vehicle 200 traveling on the roadway 201 to recognize the mobile body 900 present on the sidewalk 2102 since the visual field of the driver is obstructed by the obstacle 2103. Here, the acquisition unit 111 of the vehicle 200 acquires a camera image from the camera 160 mounted on the vehicle 200. The space detection unit 112 of the vehicle 200 detects a space on the auxiliary road based on the camera image captured by the camera 160. The interrupted section specification unit 113 of the vehicle 200 detects the sidewalk 2102 which is a section of the auxiliary road in which a part of the auxiliary road is interrupted based on the space on the auxiliary road detected by the space detection unit 112. The notification unit 115 of the vehicle 200 notifies a driver of the vehicle that the sidewalk 2102, which is a section of the auxiliary road in which a part of the auxiliary road is interrupted specified by the interrupted section specification unit 113, is present. By doing so, the driver of the vehicle 200 can drive safely and more cautiously since the mobile body 900 may run out into the vicinity of the sidewalk 2102. Note that a server may acquire an image acquired by the camera 160 of the vehicle, execute processes performed by the space detection unit 112 and the interrupted section specification unit 113, and send a notification to the vehicle.

As described above, the road management system according to the fourth example embodiment can alert a driver that a mobile body, which it is difficult for the driver to recognize, may enter the roadway due to an obstacle being installed in the auxiliary road. Thus, a driver can drive safely and more cautiously in a case where the driver drives on a roadway including an auxiliary road in which a section thereof is interrupted. Further, the safety of not only a vehicle traveling on the roadway but also a mobile body moving on the auxiliary road can be ensured. As described above, the road management system according to the fourth example embodiment can ensure the safety.

Note that although the present disclosure has been described as a hardware configuration in the above-described example embodiments, the present disclosure is not limited thereto. In the present disclosure, any processing can also be implemented by causing a processor to execute a computer program.

In the example described above, the program includes instructions (or software codes) that, when read into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope and spirit of the present disclosure.

The whole or part of the example embodiments disclosed above can be described as, but not limited to, the following supplementary notes.

### Supplementary Note 1

A road management system comprising:
space detection means for detecting a space on an auxiliary road where a mobile body other than a vehicle moves based on sensing information obtained by sensing the auxiliary road, the auxiliary road being provided on a side of a roadway where the vehicle travels;
interrupted section specification means for specifying a section of the auxiliary road in which a whole or part of the auxiliary road is interrupted based on the space on the auxiliary road detected by the space detection means; and
reflection means for reflecting the section of the auxiliary road in which a whole or part of the auxiliary road is interrupted specified by the interrupted section specification means in a database.

### Supplementary Note 2

The road management system according to supplementary note 1, wherein the sensing information includes at least one of a camera image obtained by capturing an image of a road and three-dimensional point cloud data of the road.

### Supplementary Note 3

The road management system according to supplementary note 1 or 2, wherein the sensing information is acquired by the mobile body and transmitted to the space detection means.

### Supplementary Note 4

The road management system according to any one of supplementary notes 1 to 3, further comprising brightness detection means for detecting brightness in the space on the auxiliary road detected by the space detection means, wherein
the interrupted section specification means further specifies a section of the auxiliary road in which brightness of a whole or part of the auxiliary road is less than or equal to a predetermined value based on brightness information of the space on the auxiliary road detected by the brightness detection means, and
the reflection means further reflects the section of the auxiliary road in which the brightness of a whole or part of the auxiliary road is less than or equal to a predetermined value and a date and time specified by the interrupted section specification means in the database.

### Supplementary Note 5

The road management system according to supplementary note 4, wherein the brightness detection means detects the brightness by analyzing a brightness value of the image of the auxiliary road.

### Supplementary Note 6

A road management method comprising:
detecting a space on an auxiliary road where a mobile body other than a vehicle moves based on sensing information obtained by sensing the auxiliary road, the auxiliary road being provided on a side of a roadway where the vehicle travels;
specifying a section of the auxiliary road in which a whole or part of the auxiliary road is interrupted based on the space on the auxiliary road detected by the space detection means; and
reflecting the section of the auxiliary road in which a whole or part of the auxiliary road is interrupted specified by the interrupted section specification means in a database.

### Supplementary Note 7

The road management method according to supplementary note 6, wherein the sensing information includes at least one of a camera image obtained by capturing an image of a road and three-dimensional point cloud data of the road.

### Supplementary Note 8

The road management method according to supplementary note 6 or 7, wherein the sensing information is acquired by the mobile body and transmitted to the space detection means.

### Supplementary Note 9

The road management method according to any one of supplementary notes 6 to 8, further comprising:
detecting brightness in the detected space on the auxiliary road;
specifying a section of the auxiliary road in which brightness of a whole or part of the auxiliary road is less than or equal to a predetermined value based on brightness information of the detected space on the auxiliary road; and
reflecting the section of the auxiliary road in which the specified brightness of a whole or part of the auxiliary road is less than or equal to a predetermined value and a date and time in the database.

### Supplementary Note 10

The road management method according to supplementary note 9, wherein the brightness is detected by analyzing a brightness value of the image of the auxiliary road.

### Supplementary Note 11

A non-transitory computer readable medium storing a program for causing a computer to:
detect a space on an auxiliary road where a mobile body other than a vehicle moves based on sensing information obtained by sensing the auxiliary road, the auxiliary road being provided on a side of a roadway where the vehicle travels;
specify a section of the auxiliary road in which a whole or part of the auxiliary road is interrupted based on the space on the auxiliary road detected by the space detection means; and
reflect the section of the auxiliary road in which a whole or part of the auxiliary road is interrupted specified by the interrupted section specification means in a database.

### Supplementary Note 12

The non-transitory computer readable medium according to supplementary note 11, wherein the sensing information includes at least one of a camera image obtained by capturing an image of a road and three-dimensional point cloud data of the road.

### Supplementary Note 13

The non-transitory computer readable medium according to supplementary note 11 or 12, wherein the sensing information is acquired by the mobile body and transmitted to the space detection means.

### Supplementary Note 14

The non-transitory computer readable medium according to any one of supplementary notes 11 to 13, wherein the program further causes the computer to:
detect brightness in the detected space on the auxiliary road;
specify a section of the auxiliary road in which brightness of a whole or part of the auxiliary road is less than or equal to a predetermined value based on brightness information of the detected space on the auxiliary road; and
reflect the section of the auxiliary road in which the specified brightness of a whole or part of the auxiliary road is less than or equal to a predetermined value and a date and time in the database.

### Supplementary Note 15

The non-transitory computer readable medium according to supplementary note 14, wherein the brightness is detected by analyzing a brightness value of the image of the auxiliary road.

### Reference Signs List

11, 21 SPACE DETECTION MEANS

12, 23 INTERRUPTED SECTION SPECIFICATION MEANS

13, 24 REFLECTION MEANS

22 BRIGHTNESS DETECTION MEANS

10, 20, 100, 110, 130 ROAD MANAGEMENT SYSTEM

101 ROAD MANAGEMENT APPARATUS

111 ACQUISITION UNIT

112 SPACE DETECTION UNIT

113 INTERRUPTED SECTION SPECIFICATION UNIT

114 REFLECTION UNIT

115 NOTIFICATION UNIT

150 NETWORK

160 CAMERA

200 VEHICLE

201, 301 ROADWAY

210, 211, 310, 311 SIDEWALK

2103 OBSTACLE

2101, 2102, 2104, 3104, 3105, 3106 SIDEWALK

900 MOBILE BODY

What is claimed is:

1. A road management system comprising:
at least one memory storing instructions; and
at least one processor configured to execute the instructions to:
detect a space on an auxiliary road where a mobile body other than a vehicle moves based on sensing information obtained by sensing the auxiliary road, the auxiliary road being provided on a side of a roadway where the vehicle travels;
specify a section of the auxiliary road in which a whole or part of the auxiliary road is interrupted based on the space on the auxiliary road; and
reflect the section of the auxiliary road in which the whole or part of the auxiliary road is interrupted in a database.

2. The road management system according to claim 1, wherein the sensing information includes at least one of a camera image obtained by capturing an image of a road and three-dimensional point cloud data of the road.

3. The road management system according to claim 1, wherein the sensing information is acquired by the mobile body and transmitted to the road management system.

4. The road management system according claim 1, wherein the at least one processor is further configured to execute the instructions to:
detect brightness in the space on the auxiliary road, wherein the road management system is configured to:
specify a section of the auxiliary road in which brightness of a whole or part of the auxiliary road is less than or equal to a predetermined value based on brightness information of the space on the auxiliary road, and
reflect the section of the auxiliary road in which the brightness is less than or equal to the predetermined value and a date and time in the database.

5. The road management system according to claim 4, wherein the at least one processor is further configured to execute the instructions to: detect the brightness by analyzing a brightness value of the image of the auxiliary road.

6. A road management method comprising:
detecting a space on an auxiliary road where a mobile body other than a vehicle moves based on sensing information obtained by sensing the auxiliary road, the auxiliary road being provided on a side of a roadway where the vehicle travels;
specifying a section of the auxiliary road in which a whole or part of the auxiliary road is interrupted based on the detected space on the auxiliary road; and
reflecting the specified section of the auxiliary road in which a whole or part of the auxiliary road is interrupted in a database.

7. A non-transitory computer readable medium storing a program for causing a computer to execute:
detecting a space on an auxiliary road where a mobile body other than a vehicle moves based on sensing information obtained by sensing the auxiliary road, the auxiliary road being provided on a side of a roadway where the vehicle travels;
specifying a section of the auxiliary road in which a whole or part of the auxiliary road is interrupted based on the detected space on the auxiliary road; and
reflecting the specified section of the auxiliary road in which a whole or part of the auxiliary road is interrupted in a database.
